(19) United States
(12) Patent Application Publication
(10) Pub. No.: US 2008/0306762 A1
(43) Pub. Date: Dec. 11, 2008

(54) System and Method for Managing Absenteeism in an Employee Environment

(76) Inventor: Terry L. James, Fairview, TX (US)

Correspondence Address: BAKER BOTTS L.L.P., 2001 ROSS AVENUE, SUITE 600, DALLAS, TX, 75201-2980, US

(21) Appl. No.: 11/760,437

(22) Filed: Jun. 8, 2007

(51) Int. Cl. G06Q 50/00; G06Q 10/00

(52) U.S. Cl. 705/2

(57) ABSTRACT

A system for managing absenteeism includes an absence manager, employees, and healthcare individuals. Absence manager can capture health-related data associated with employee and reason for employee absence. Healthcare individuals can receive a report associated with the employee that is updated in real time as new data is captured. Healthcare individuals determine an intervention plan for the employee based on the health-related data, reason for absence, and any other relevant data. Healthcare individuals can exchange data with employee related to the intervention plan with the employee.

### TECHNICAL FIELD OF THE INVENTION

This invention relates in general to health management, and more particularly to a system and method for managing absenteeism.

### BACKGROUND OF THE INVENTION

Companies lose approximately 2.8 million work days each year because of employee injuries and illnesses, according to the U.S. Bureau of Labor Statistics. Companies can reduce the number of absences per year by introducing immediate care for acute health related events and providing risk management for an individual or population. By reducing the number of absences per year, the company can increase it's productivity and profitability. The inability to plan for such absences forces companies to hire last-minute temporary staff, pay costs related to illness, pay more overtime, and add a staffing margin to replace anticipated lost labor, all of which contributes to total cost. There are other hidden costs associated with absenteeism, such as lost productivity as a result from absent employees. Costs associated with absenteeism can be controlled if employers are tuned in to the health needs of employees. Currently, there is a lack of employee accountability for absences. Employees do not feel accountable for absences since employees are only reporting absences to an automated system. In addition, it is difficult for management to use absenteeism data to amend the work schedule because absenteeism reports are not in real time. Additionally, companies are not being proactive to reduce employee absences because they cannot integrate data from absenteeism. Company costs related to unscheduled absences can be reduced through an absence manager with other health information to develop cohesive strategies of intervention.

An insurer is a financier of medical services. The insurer only becomes a payer because the employer shifted some of the risk by paying the insurer to assume any expenses in excess of the premium payments. In reality, the insurer is using the employer's money and employee's money to pay the bills in hopes that there is some money left over at the end of the day.

An insurer generally is in business to make a profit. A significant profit source is the difference between the money it takes in (premiums) and the money it pays out (medical expenses). Payment for medical services becomes a primary cost. As a result, an insurer is highly motivated to limit the amount of money it pays to hospitals, doctors, or other healthcare providers. In order to limit monies paid out for medical services, insurers also have implemented a variety of plans, including PPOs, HMOs, capitation arrangements, contracted services, drug purchase agreements, and the like. The plans are multiple and diverse, and all designed to increase profits for the insurer by reducing cost (i.e. money paid for medical services).

An insurer could profit more if it could take appropriate steps to provide an intervention plan to an absent employee to reduce short term disability and to prevent a short term disability from turning into a long term disability by early intervention with a healthcare individual. Additionally, insurer could properly adjust premium levels if insurer knew the past and current absenteeism data for each employee. Insurer can reduce short term and long term disability costs. In addition, insurer can reduce costs as a result of the effectiveness of early notification and proper health management.

Both companies and insurers can increase profitability by properly managing absenteeism of employees. Creating intervention plans that focus on the employee or employee population, in our opinion, can significantly reduce the occurrence of absenteeism and further reduce costs related to absenteeism. Intervention plans can force employees to be held accountable for their absences. Employee absences can be reduced and prevented if interventions are timely and integrate employee's absenteeism data with other health data of the population to develop a long term strategy of risk reduction for a given employee or population. Interventions make use of each employee's health data and current reason for absence. Such intervention plans are vitally important because the intervention plans are tailored to the health concerns for each individual employee, which will result in fewer absences.

### SUMMARY OF THE INVENTION

From the foregoing, it may be appreciated that a need has arisen for an improved process for achieving superior management of absenteeism in order to reduce healthcare costs. Presently, absent management solutions focus on who is absent and who needs to know within the company. They are essentially administration tools, and not health management tools. In accordance with the present invention, disadvantages and problems associated with previous techniques for managing absenteeism may be reduced or eliminated.

In accordance with one embodiment of the present invention, a method for managing absenteeism in an employment environment is provided. The method includes capturing health-related data from an employee and capturing a reason for current absence by the employee. In addition, healthcare individual has access to employee. The method also includes receiving an absence report associated with the employee, such that the report is updated in real time. The method includes interacting with the employee at a remote location with a healthcare individual and determining an intervention plan for the employee based on the health-related data, the reason for current absence, and any additional data received from employee. Additionally, the method includes exchanging data related to the intervention plan with the employee.

In accordance with another embodiment of the present invention, the method for managing absenteeism includes determining a surveillance plan for the employee based on the health-related data, the reason for absence, and additional data. A healthcare individual can follow up with the employee based on the surveillance plan. The method further includes a risk management feature. By identifying one or more relevant risk factors from health-related data and analyzing the risk factors collected from the employee or population, it is possible to design an intervention plan to modify those risk factors and reduce future absenteeism of an employee or population.

Important technical advantages of certain embodiments of the present invention include a reduction of employee absences. This is due, at least in part, to the absence manager, which is capable of automating data capture, reporting absence, and forwarding data to a healthcare individual. System can reduce length of employee absence by providing early intervention to absent employees from healthcare individuals. System can also prevent fraudulent absences by placing accountability on absent employee to talk with a healthcare individual when calling in sick.

Other important technical advantages of certain embodiments of the present invention include reducing future absences. Absence manager can store health data and absence data for entity's employees. Healthcare individuals can view data for each employee and provide appropriate intervention plans, which can reduce future employee absences. For example, healthcare individuals can view all employees who have reported absences due to stress, identify employees at risk of stress, and provide a stress relief intervention plan to these employees. Additionally, absence manager allows for entity to track absenteeism and measure cost of absenteeism by directly analyzing utilization data of the employer. For example, entity can determine if employees participating in wellness program are absent less frequently than those employees who are not participating.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram that illustrates a system for managing absenteeism in accordance with a particular embodiment of the present invention;

FIG. 2 is a simplified block diagram that illustrates the features of the absence manager used by a healthcare individual applying an intervention plan in accordance with a particular embodiment of the present invention;

FIG. 3 is a simplified flowchart that illustrates an example method for collecting data and managing absenteeism in accordance with an embodiment of the present invention;

FIG. 4 is an example listing of health risk appraisal data;

FIG. 5 is an example of an absence report in accordance with an embodiment of the present invention; and

FIG. 6 is a simplified flowchart that illustrates an example method for managing absenteeism in accordance with an embodiment of the present invention.

### DETAILED DESCRIPTION OF THE INVENTION

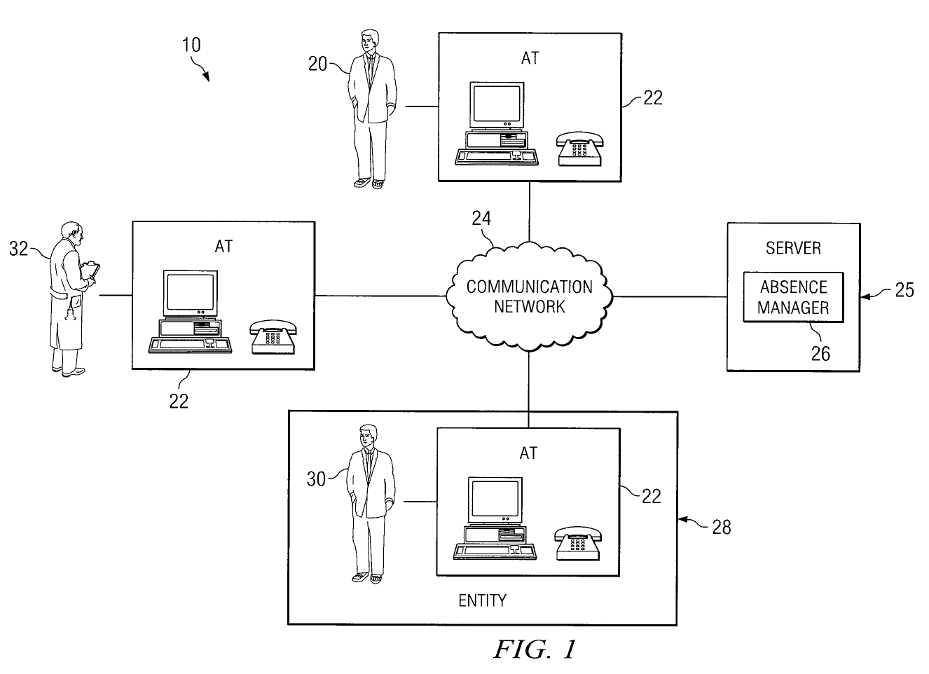

FIG. 1 is a simplified block diagram of a system 10 that manages absenteeism. According to the embodiment, system 10 includes an absent employee 20, access terminal 22, communication network 24, server 25, absence manager 26, entity 28, healthy employees at entity 30, and healthcare individual 32.

In accordance with the teachings of the present invention, communication system 10 achieves an effective way for entities to manage employee absences. Absent employee 20 uses access terminal 22 to communicate with absence manager 26 to report absence from work and the reason why employee is absent. Absence manager 26 is operable to store health data 56 of employees, to receive and record reason for employee's absence, and to notify appropriate employees of employee's absence. Absence manager 26 is further operable to transmit absent employee's health data 56 to healthcare individual 32 and to forward absent employee's call to healthcare individual 32. Healthcare individuals 32 can review absent employee's health data 56 to provide appropriate intervention and converse in real time with employee.

System 10 offers advantages to an entity 28 managing absenteeism. This is due, at least in part, to absence manager 26, which is capable of automating data capture and notification, reporting absence, and forwarding data to a healthcare individual 32. System can reduce length of employee absence by providing early and timely intervention to absent employee from healthcare individuals 32. System can also prevent fraudulent absences by placing accountability on absent employee to talk with a healthcare individual 32 when calling in sick.

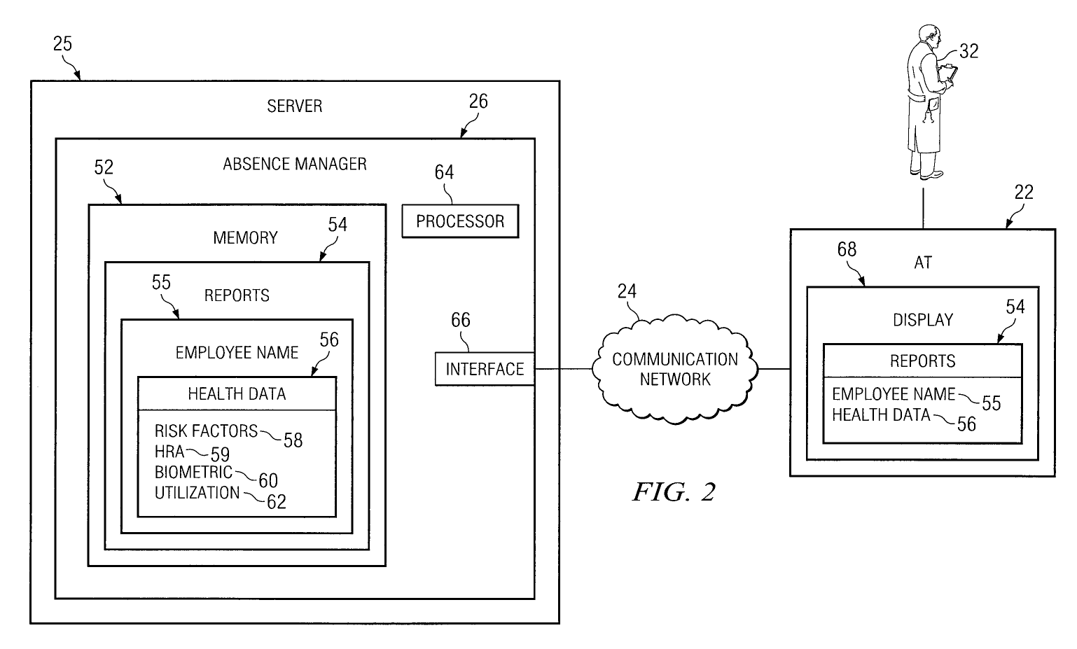

System offers additional advantages to an entity 28 managing employee absences. Absence manager 26 can store health data 56 and absence data for entity's employees. Healthcare individuals 32 can view data for each employee or population in order to design future risk management plans, which can reduce future employee absences. For example, healthcare individuals 32 can view all employees who have reported absences due to stress, and healthcare individuals 32 can provide a stress relief intervention plan to these employees or population. Additionally, absence manager 26 allows for entity 28 to track absenteeism and to directly measure cost of absenteeism by accessing employee's utilization data and cost avoidance. For example, entity 28 can determine if employees participating in wellness program are absent less frequently than those employees who are not participating. Details relating to these operations are explained below in FIG. 2.

According to the illustrated embodiment, system 10 provides services such as communication sessions to endpoints such as access terminal 22. A communication session refers to an active communication between endpoints. Information may be communicated during a communication session. Information may include voice, data, text, audio, video, multimedia, control, signaling, and/or other information. Information may be communicated in packets, each comprising a bundle of data organized in a specific way for transmission.

System 10 may utilize communication protocols and technologies to provide communication sessions. Examples of communication protocols and technologies include those set by the Institute of Electrical and Electronics Engineers, Inc. (IEEE) standards, the International Telecommunications Union (ITU-T) standards, the European Telecommunications Standards Institute (ETSI) standards, the Internet Engineering Task Force (IETF) standards (for example, IP such as mobile IP), or other standards.

According to the illustrated embodiment, absent employee 20 represents any entity employee, who is reporting an absence. For example, an absent employee 20 can report any type of absence, such as acute illness, chronic illness, stress, family issues, etcetera.

According to the illustrated embodiment, access terminal 22 represents any suitable device operable to communicate with a communication network 24. For example, an employee may use access terminal 22 to communicate with a communication network 24 to report absence to absence manager 26. Access terminal 22 may comprise, for example, a personal digital assistant, a computer such as a laptop, a cellular telephone, a pager, a mobile handset, and/or any other device operable to communicate with system 10. Access terminal 22 may be a mobile or fixed device.

System 10 includes a communication network 24. In general, communication network 24 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding.

Servers 25 are generally operable to provide an interface between employee health data 56 and healthcare individuals 32. One or more servers may be web application servers or simple processors operable to allow healthcare individuals 32 to view and process employee health data 56 and absence reports 54 via the communication network 24 using a standard user interface language such as, for example, the HyperText Markup Language (HTML). In some embodiments, one or more servers may be physically distributed such that each server 25, or multiple instances of each server, may be located in a different physical location geographically remote from each other. In other embodiments, one or more servers may be combined and/or integral to each other. One or more servers may be implemented using a general purpose personal computer (PC), a Macintosh, a workstation, a UNIX-based computer, a server computer, or any other suitable processing device.

In some embodiments, servers 25 are operable to provide security and/or authentication of employees reporting absences or other employees or healthcare individuals 32 attempting to access absence manager 26.

In particular embodiments, one or more servers are web application servers operable to communicate dynamically updated information to particular access terminal 22 via communication network 24. For example, one or more servers may communicate dynamically updated information of absence report to particular access terminals 22 via communication network 24.

Server 25 further comprises a memory that may be accessed or otherwise utilized by one or more components of absence manager 26. The memory may take the form of volatile or non-volatile memory including, without limitation, magnetic media, optical media, random access memory (RAM), read-only memory (ROM), removable media, or any other suitable local or remote memory component. In general, the server 25 memory may store various data including employee reports 54.

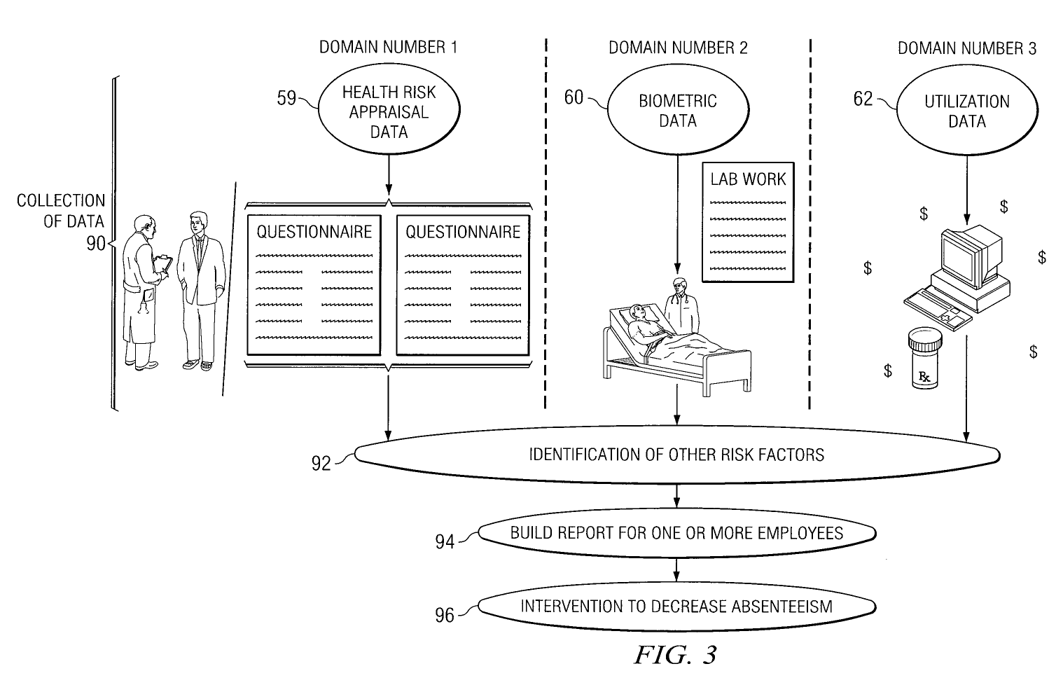

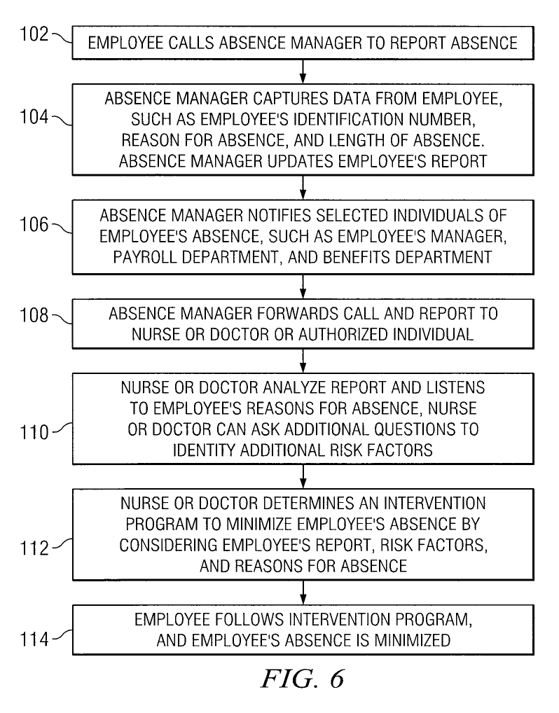

Absence manager 26 is operable to request data, receive data, process data, store data, transmit data, convert data, and sort data for a multitude of purposes. Absence manager 26 has three parts: i) capturing data and performing logic (for example, absence manager knows whether to forward call to healthcare individual); ii) generating employee absence reports 54; and iii) notifying appropriate individuals. Healthcare individuals 32 can interact with absence manager 26 to provide an intervention for absent employees. Details relating to providing an intervention based on data captured are explained below in FIG. 2 and FIG. 3. Absence manager 26 can capture a variety of data. For example, absence manager 26 can capture employee's name, employee's identification number, risk factors 58, health risk appraisal data 59, biometric data 60, utilization data 62, start of absence, return date, and reasons for absence. Details relating to this data are explained below in FIG. 2 and FIG. 3. Absence manager 26 can capture this data manually or data capture can be automated. For example, an authorized individual can manually enter an employee's risk factors 58 and utilization data 62. Alternatively, absence manager 26 can automate this data capture by prompting the employee to enter his employee identification number and to give a reason for absence. Absence manager 26 can save data as electronic text form, an audio file, or any appropriate data file. In the preferred embodiment, employee will call absence manager with a telephone to report an absence. Absence manager 26 is operable to convert voice data into text data, such that all data on report is in text form. Absence manager 26, including data capture, can be customized and configurable by authorized individuals, such as entity 28 or healthcare individuals 32. For example, entity ABC can set up their absence manager 26 to prompt employee to use phone key pad to punch in employee identification number and later prompt user to orally give reason for absence. More details relating to data capture are explained below in FIG. 2 and FIG. 6.

Absence manager 26 can generate employee absence reports 54. Reports 54 can be viewed on a web site by authorized individuals or reports 54 can be sent via email to selected individuals. Employee absence reports 54 are a valuable record that provide entity 28 and healthcare individual 32 with data associated with employee absences. Entity 28 can sort this data a variety of ways to calculate the cost of absenteeism. For example, entity 28 can quickly sort and process data in employee absence reports 54 to determine the average days absent for an employee participating in a wellness program and average days absent for an employee not participating in a wellness program. In another example, healthcare individual 32 can quickly sort out entity's population that was absent due to stress and apply a stress relieving intervention plan for these employees, which will result in fewer absences. More details relating to an entity 28 or healthcare individual 32 using the report to reduce absenteeism and lower costs are explained below in FIG. 2. Absence manager 26, including employee absence reports 54, can be customized and configurable by authorized individuals to display a variety of data fields related to absenteeism. For example, company ABC may choose to include a unique data field, such as employee risk level. Authorized individuals can determine if employee is high risk, medium risk, or low risk. Entities and healthcare individuals 32 can develop intervention plans more efficiently and effectively by using customizable data fields in an absence report. Employee absent reports 54 allow authorized individuals to know who is absent, when are they absent, when are they expected to return, how frequent are they absent, and reason for absence as well as other valuable information.

Absence manager 26 can notify appropriate employees in entity 28 and healthcare individuals 32 of when employee is reporting an absence. Absence manager 26, including notifying others of employee absence, can be customized and configurable by authorized individuals. This feature allows for automated and instant communication to relevant parties. For example, absence manager 26 can be customized for each employee, such that absent employee's manager and clients that employee was scheduled to meet are notified of employee's absence. Additionally, entity's payroll and benefits department can be notified as well, as well as any other individual. Absence manager 26 can be customized to notify these parties by email, phone call, or any appropriate method of notification. Additionally, absence manager 26 can be customized to only notify certain individuals with certain data. For example, healthcare individual 32 may have access to entire report, but a payroll department may only have access to the data fields related to the length of absence. Additional details of absence manager 26 are listed below in FIG. 2.

Entity 28 is generally where the employee works. Entity 28 can include a company, a university, a hospital, etcetera. Entities can use absence manager 26 to help measure costs of absenteeism. Entities pay several costs associated with absenteeism: direct costs from hospitals, direct costs from doctors, direct costs associated with medicine, lost productivity costs from missing employee, costs of paying for temporary employees to replace absent employees, and costs associated with short term and long term disabilities. These costs are hard to track, but absence manager 26 allows entities to effectively measure costs of absenteeism. Entities can use absence manager 26 to reduce absenteeism, which will result in lowering costs.

Employees 30 generally work at entity 28 who may need to know of absence. Some of these employees can be notified of the absent employee. Absence manager 26 is configurable to select which employees will be notified for each employee's absence. Generally, employees that are notified include absent employee's manager, absent employee's secretary, payroll department, and benefits department. Any employee of entity 28 can be notified of absence. Employee can be any individual selected to be notified of absence, including individuals outside of entity 28 who had meetings scheduled with absent employee. Employees may be notified of absence by voicemail, pager, email, or text messaging. Absence manager 26 notifies appropriate employees in an automated and real time environment, which minimizes disruption caused by absence.

Healthcare individuals 32 can provide an intervention plan for an employee based on employee's data captured in absence reports 54. Healthcare individual 32 can receive call from absent employee and receive absence report on access terminals 22. Healthcare individual 32 can apply acute intervention for illnesses that are causing absences. Healthcare individuals 32 can apply specific and timely intervention plans for different employees based on employee's health data 56 and reasons for illness, which will reduce the number of days an employee is absent. Timeliness of intervention is very important for acute events. By providing an intervention to an acute event soon after absence is reported by employee, employee's beneficial health outcomes increases. Intervention to acute event can include first aid, primary level care, triage, education, evaluation, education, etcetera. Additionally, healthcare individual 32 can apply intervention plans in a preventative way based on employee health data 56 stored on absence manager 26. For example, healthcare individual 32 may enroll all heart attack victims in a heart smart plan, which will prevent absences in the future. Healthcare individuals 32 can include physicians, nurses, or any authorized individual to make intervention decisions using absent employee's health data 56. After an employee reports 54 an absence, employee's call can be automatically transferred to a healthcare individual 32 by the absence manager 26 for further evaluation and direct communication with the employee. Employees will be less likely to report fraudulent absences when they are required to explain their absence to a healthcare individual 32 on the phone. Additional details of healthcare individuals 32 applying intervention plans based on employee's health data 56 transmitted from absence manager 26 are listed below in FIG. 2.

In another embodiment, healthcare individual 32 can be under contract with an insurance carrier. Insurance carrier can use absence manager 26 to maximize profitability. Insurance carriers can charge premiums to entities for short term and long term disability. The amount the insurance carrier quotes entities for the premiums is based upon risk. Insurance carriers can use absence manager 26 to receive immediate intelligence and data on employee population of entity 28 to limit the costs associated with employee's healthcare. For example, healthcare individual 32 can determine an appropriate intervention plan for employee based on health data 56, the employee absence record, and reason for absence. This intervention plan can prevent an illness from becoming a short term disability, and prevent a short term disability from becoming a long term disability. Additionally, if a high risk employee gets ill, then carriers can budget for a high risk patient that may go on long term disability. Therefore, absence manager 26 can provide data that has value at the insurer level and at the caretaker level.

In an alternative embodiment, employee 20 can contact healthcare individual 32 to report an absence. Healthcare individual 32 can capture health data 56 and reason for absence. Healthcare individual 32 can determine an intervention for employee based on health data 56 and reason for absence. Healthcare individual 32 can provide a timely and specific intervention to employee 20 and use the communication network 24 to notify appropriate individuals.

Note that because the terminology associated with some of the elements of system 10 is malleable, it is helpful to offer some initial descriptions that address their meanings. As used herein, health management is for managing acute events. Health management for acute events can include acute care, evaluation, triage, treatment, education, first aid, primary level care, or referral to another healthcare individual. As used herein, risk management is for managing the long term risk modification of risk factors that are driving morbidity and its associated healthcare costs. As used herein, an intervention may be defined as an introduction of a variable (behavioral, chemical, process, etc.) that is designed to affect or modify any absence for a target employee or group. Therefore, an intervention may include a change, addition, or modification to any relevant risk factor associated with employee. In the context of an intervention, a number of modules may be introduced to affect behaviors of the targeted individual or group. The term ‘module’ is simply a task to be completed by the targeted employee or population. The task could be for either health management and/or risk management. The term module is defined in more detail below.

Within the structure of a given intervention plan, examples of a module for employee may include changing a prescription from medicine A to medicine B or a change in treatment from Dr. A to Dr. B (or a treatment protocol being changed while remaining under the care of the same physician). An example of an activity shift could include a recommendation to increase a level of physical fitness, to refrain from certain activities that pose an increased health risk, or to take precautions based on a particular set of symptoms or conditions identified for that particular employee. Other behavioral changes may stem from data or reports 54 that suggest certain categorical groups (e.g. age, gender, race, etc.) or populations may be more susceptible to designated afflictions (e.g., a healthcare individual 32 could recommend annual mammograms for women over the age of 35). In still other scenarios, the intervention could involve a process to be implemented, whereby the employee may be asked to interact with a nurse every twelve hours, immediately report cold symptoms to a primary physician, or log daily testing information in a journal. All of these modifications may be part of one or more designated modules for the target population. Such modules are discussed more fully below.

Once a relevant risk factor 58 has been identified, a specific intervention may be introduced that is designed to modify the risk factor and reduce absenteeism. For example, if high blood pressure or high blood sugar is discovered to be a risk factor in an employee population, an intervention would be applied (e.g. weight management) to that population to reduce the absenteeism associated with obesity.

The proposed interventions are generally of two kinds: behavioral based and non-behavioral based. Consider the case where there is absenteeism associated with recurrent physician visits for allergies of employees of Company Alpha. A non-behavioral based intervention could be designed so that affected employees who participated in an allergy intervention plan with appropriate injections will minimize lost work days due to allergic reactions. A behavioral based intervention or module could add an interactive journal designed to facilitate a change in how to behave toward the use of emergency medical services, skills on how to evaluate acute medical events, etc. Combining one intervention to change behavior with another intervention to change a point of service or a level of care optimizes reducing absenteeism.

As used herein, the term “module” includes any task to be completed by the targeted employees. The modules are designed after identifying the relevant risk factors 58 associated with the target population. Hence, the identified relevant risk factors 58 are used as the basis for configuring the modules, which can be interactive and which specifically address the (potentially modifiable) targeted clinical risk factors 58, character observations, or disease states of the target population. Considerable time and effort may be expended in designing the precise modules that will yield the most beneficial results for the target group and, thereby, alleviate the absenteeism and healthcare costs for a given company. Thus, the modules are designed to reduce absenteeism and related healthcare expenses for a given individual or group, as determined by the identification of relevant risk factors 58. The modules may also achieve a reduction in absenteeism and related healthcare expenses by modifying the choices of the individual so that the individual chooses new behaviors or abandons old behaviors that are costly.

Therefore, a module could include virtually any action, exercise, or assignment that may affect an individual's beliefs, feelings, thoughts, or behaviors. This is inclusive of an employee refraining from doing some action or intentionally not participating in certain endeavors. There could be a series of successive modules to be completed by an individual in a particular order, or the modules could be completed in a random fashion. A module is tailored specifically for a participant or a group of individuals and, therefore, modules are considerably flexible and malleable. A module may be completed during normal business hours (potentially under the supervision of an administrator), during non-business hours where the ‘honor system’ is employed, or anytime using an access terminal 22. Furthermore, an incentive program can be implemented, such that more employees will comply with intervention plans.

Note that the modules associated with risk management are more process-oriented, as opposed to information-oriented, so that their focus is on the facilitation of change in the individual. Alternatively, health management interventions can be information-oriented. The modules are designed to allow the employee to acquire skills and life applications of the learned information. The user may be asked to respond affirmatively in order to address certain subject matter. In addition, the patient may be required to perform specific behaviors. Rewards may then be given based on the performance of the modules by the individual, as he completes, applies, acquires, or participates in proscribed assignments within the modules.

A module could include educational tools, such as a booklet or computer program designed to address the illness, behavior, or issue presented by the target individual or group. For example, if the issue were stress management, a booklet could include information about proper diet (e.g. inclusive of caffeine restrictions), breathing exercises, time management, and sleeping suggestions. The booklet could include fill-in the blank questions that quiz the individual on the lessons learned.

The module could also solicit personal reflections from the individual. Note that such introspection is a powerful tool for addressing the patient's psyche at a fundamental level. Completion of question and answer sections could be part of the module, but probing deeper by asking difficult and private questions may prove far more beneficial. This is critical. Knowledge, by itself, does not necessarily change behavior. The individual needs to make a conscious decision to accept the knowledge and then incorporate these teachings into their own life. Asking thoughtful questions that query a person as to how they are feeling, thinking, and processing the presented information helps to foster their development.

Consider the following two questions that are illustrative of this concept. These questions could be provided in any potential module. Question 1: How do you feel about your current health self-assessment? What surprises you and what concerns you? Please explain. Question 2: Based on all of the information that you have learned so far in this module, what is your number one reason for wanting to take responsibility for your health? Such questions are far removed from simple fill-in-the blank questions or insignificant true/false questions.

A wise philosopher once noted: to know, and to not do, is to not know. Such an aphorism is relevant in the realm of healthcare. Slipping a pamphlet under the door of every employee of a company who has diabetes may not yield a change in behavior in these individuals. Facilitating change in the individual is paramount. For example, in the case of a diabetic individual, the critical issue is to not only get the individual to understand the value of blood sugar levels to their own wellness, but to make decisions that ensure that those blood sugar levels remain in an optimal range. Note that this recognition and application by the individual exhibits the knowledge and application components of the process being merged. After suffering an unfortunate incident or trauma (e.g. a seizure or a neuropathy), many diabetics might recount that they were made aware of a certain risk or a potential danger. For example, an individual who previously participated in an intervention plan may explain, “Yes, I was once told of the dangers of failing to maintain my blood sugar levels. I remember completing a crossword puzzle about it.” Such a response elucidates the futility of many wellness programs. Healthcare expenditures and related absenteeism have little to do with what people know or do not know. Instead, healthcare expenditures and absenteeism have far more to do with how people think, feel, believe, and behave, and, further, the choices that they ultimately make to live their lives. Thus, many of the modules presented herein are designed to facilitate the process of change so that an individual makes new choices in life that reduce the risk for disease and associated absences. Changing the thought processes, belief, and choices of the target individuals is key.

Modules can also be related to physical exercises to be completed by the participants of the target group. An honor system may be employed for such a module or the participant may wear some type of activity monitor (e.g. a pedometer for tracking walking, a heart rate monitor for tracking other activities, etc.). In addition, a module may include work completed using access terminal 22 and, potentially, monitored by an on-line administrator. A module could also simply be the completion or achievement of a specific goal. In the case of a person with high cholesterol, a reduction of the individual's cholesterol level by fifty points may signify performance or completion of the module. Other modules could include the ingestion of medication in the presence of a medical individual or an administrator of the intervention. For example, a diabetic may be reluctant to take his proper insulin dosages and, therefore, present a significant financial and absence risk for a company. A module could be designed specifically to address this problem, whereby a full month of consistent dosages (reflected by a nurse's log or by periodic measurement of blood sugar levels for this individual) reflects the completion of a module. The subsequent module for this individual could include a three-month period of consistent medication, which can be reflected by three months of consistent blood sugar levels being recorded in a table or chart verified by an attending nurse.

Other modules may be completed in a group setting. For example, if unplanned pregnancies are an issue causing absences for a company, a module could include female participation in a group meeting that includes women who previously experienced an unplanned pregnancy. Note that the group dynamic provides an opportunity for individuals to encourage each other in participating in the module. Thus, certain modules may solicit participation by an entire group of individuals for successful completion of the module. This group dynamic concept is a distinct issue that holds value.

Other modules could implement the use of external sources. For example, one module associated with an unplanned pregnancy intervention could include regular attendance at Planned Parenthood meetings for three months, where information is regularly exchanged about contraception, proper nutrition, and exercise. Similarly, regular attendance at Alcoholics Anonymous could be required (for a specific period of time) for someone who is an alcoholic and who is also diabetic. Other variations and permutations in the design of the modules may be ascertained by simply focusing on the correctable and modifiable behaviors of the underlying target individual or group: behaviors which affect absenteeism.

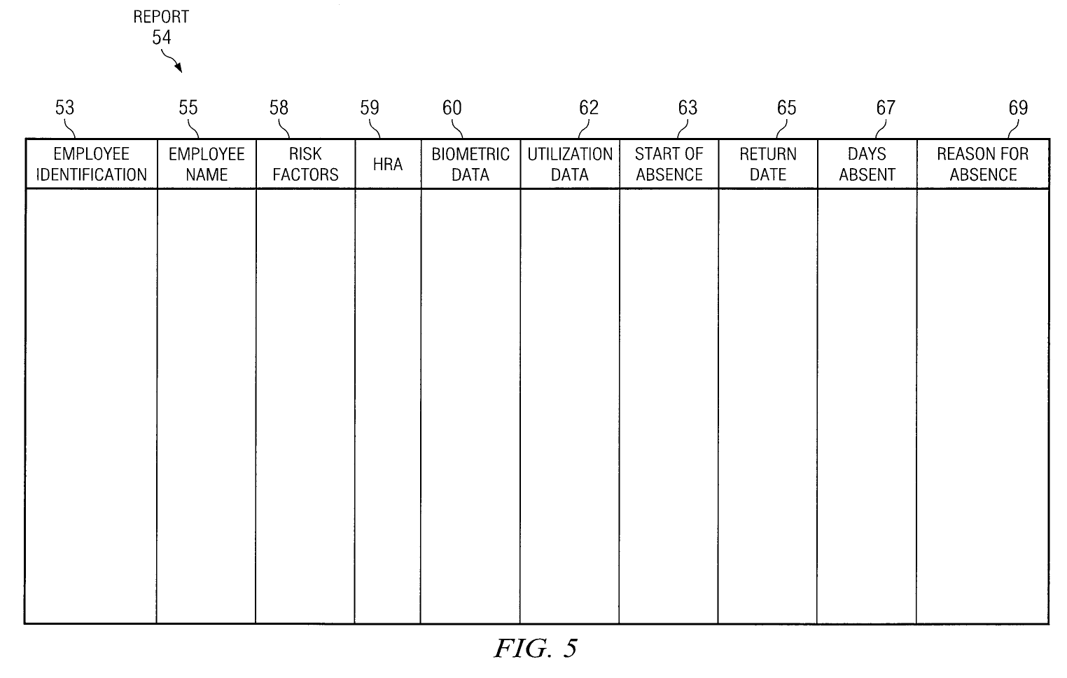

FIG. 2 illustrates the features of absence manager 26 used by healthcare individuals 32 applying an intervention plan in accordance with a particular embodiment of the present invention. Absence manager 26 is located on server 25. Absence manager 26 includes memory 52, which stores employee absence reports 54. Employee absence reports 54 include employee name 55 and employee health data 56. Employee health data 56 includes risk factors 58, health risk appraisal data 59, biometric data 60, and utilization data 62. Reports 54 are customizable and can include a multitude of other data fields including the data fields described below in FIG. 5. Absence manager 26 also includes processor 64 and an interface 66 to communicate with communication network 24. Healthcare individual 32 is able to view employee absence report displayed 68 on access terminal 22. Additionally, absence manager 26 can forward employee's call to healthcare individual 32 via communication network 24 and access terminal 22. Healthcare individual 32 can provide an intervention to employee, such that employee's absence is minimized. Healthcare individual 32 can customize intervention for employee based on the data from health report and reason for employee's absence. Other architectures and components of absence manager 26 may be used without departing from the scope of this disclosure. Additional details of healthcare individuals 32 providing interventions based on employee's health data 56 transmitted from absence manager 26 are listed below in FIG. 6.

In another embodiment, healthcare individual 32 can use absence manager 26 to sort and process employee health data 56 to provide intervention plans to population of employees. Participation in the intervention plans will result in fewer future absences. Additional details of healthcare individuals 32 providing preventative intervention plans based on employee's health data 56 transmitted from absence manager 26 are listed below in FIG. 3 and FIG. 6.

Software and/or hardware may reside in absence manager 26 and/or access terminals 22 and/or server 25 in order to achieve the teachings of the features of the present invention.

Note that, due to their flexibility, these components may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of absence manager 26 and/or access terminals 22 and/or server 25 in the context of system 10 and, accordingly, they should be construed as such.

It should be noted that the internal structure of the system of FIG. 2 is versatile and can be readily changed, modified, rearranged, or reconfigured in order to achieve its intended operations or additional operations. Additionally, any of the items within FIGS. 1 and 2 may be combined, where appropriate, or replaced with other functional elements that are operable to achieve any of the operations described herein.

According to the illustrated embodiment, access terminal 22 represents any suitable device operable to communicate with a communication network 24. For example, an employee may use access terminal 22 to communicate with a communication network 24 to report absence to absence manager 26. Access terminal 22 may comprise, for example, a personal digital assistant, a computer such as a laptop, a cellular telephone, a pager, a mobile handset, and/or any other device operable to communicate with system 10. Access terminal 22 may be a mobile or fixed device.

System 10 includes a communication network 24. In general, communication network 24 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding.

Servers 25 are generally operable to provide an interface between employee health data 56 and healthcare individuals 32. One or more servers 25 may be web application servers or simple processors operable to allow healthcare individuals 32 to view and process employee health data 56 and absence reports 54 via the communication network 24 using a standard user interface language such as, for example, the HyperText Markup Language (HTML). In some embodiments, one or more servers may be physically distributed such that each server 25, or multiple instances of each server 25, may be located in a different physical location geographically remote from each other. In other embodiments, one or more servers may be combined and/or integral to each other. One or more servers 25 may be implemented using a general purpose personal computer (PC), a Macintosh, a workstation, a UNIX-based computer, a server computer, or any other suitable processing device.

In some embodiments, servers 25 are operable to provide security and/or authentication of employees reporting absences or other employees or healthcare individuals 32 attempting to access absence manager 26.

In particular embodiments, one or more servers 25 are web application servers operable to communicate dynamically updated information to particular access terminals 22 via communication network 24. For example, one or more servers may communicate dynamically updated information of absence report to particular access terminals 22 via communication network 24.

Server 25 further comprises a memory that may be accessed or otherwise utilized by one or more components of absence manager 26. The memory may take the form of volatile or non-volatile memory including, without limitation, magnetic media, optical media, random access memory (RAM), read-only memory (ROM), removable media, or any other suitable local or remote memory component. In general, the server 25 memory may store various data including employee reports 54.

Absence manager 26 is operable to request data, receive data, process data, store data, transmit data, convert data, and sort data for a multitude of purposes. Absence manager 26 has three parts: i) capturing data, providing logic, such as accessing employee, and communicating with a healthcare individual; ii) generating employee absence reports 54; and iii) notifying appropriate individuals. Healthcare individuals 32 can interact with absence manager 26 to provide an intervention plan for absent employees. Absence manager 26 can capture a variety of data. For example, absence manager 26 can capture employee's name, employee's identification number, risk factors 58, health risk appraisal data 59, biometric data 60, utilization data 62, start of absence, return date, and reasons for absence. Absence manager 26 can capture this data manually or data capture can be automated. For example, an authorized individual can manually enter an employee's risk factors 58 and utilization data 62. Alternatively, absence manager 26 can automate this data capture by prompting the employee to enter his employee identification number and to give a reason for absence. Absence manager 26 can save data as electronic text form, an audio file, or any appropriate data file. Absence manager 26 is operable to convert voice data into text data, such that all data on report is in text form. Absence manager 26, including data capture, can be customized and configurable by authorized individuals, such as entity 28 or healthcare individuals 32. For example, entity 28 ABC can set up their absence manager 26 to prompt employee to use phone key pad to punch in employee identification number and later prompt user to orally give reason for absence. More details relating to data capture are explained below in FIG. 6.

Health data 56 is analyzed by healthcare individuals 32 to provide an appropriate intervention plan customized to employee. Health data 56 can include risk factors 58, health risk appraisal data 59, biometric data 60, utilization data 62, and any other data related to employee's health.

Risk factor 58 is a clinical observation that has been statistically demonstrated to participate in the development of a given disease. Healthcare individuals 32 can determine risk factors associated with employee by reviewing health data 56 and analyzing absence report or asking employee questions on the phone or through email. For example, if a person is sedentary, obese, or is a smoker, the patient has clinical risk factors 58 for heart disease. However, there are other clinical observations that would not qualify as a “clinical risk factor.” For example, the fact that the patient was a certain height or had poor vision would not necessarily qualify as a clinical risk factor for heart disease.

Clinical risk factors 58 tell you if someone is at risk for developing a disease or condition, but clinical risk factors 58 do not tell you when that disease process is likely to occur, the length of absence caused by disease process, or its potential cost for the party bearing the economic risk.

By merging clinical risk factors 58 with other data domains, healthcare individual 32 can determine a proper intervention to provide health management of acute events and acute surveillance in addition to risk management for long term risk modification of risk factors. For example, a healthcare individual 32 can determine that an employee who has risk factors 58 related to smoking may receive different acute intervention than an employee who has no risk factors 58. Healthcare individual 32 can provide acute surveillance by requesting that a smoker with a respiratory infection call back every twelve hours so that healthcare individual 32 can track the employee's illness. Alternatively, healthcare individual 32 may not need to provide acute surveillance for a non-smoker with a respiratory infection since this employee does not pose as high a risk.

As used herein, health risk appraisal data 59 represents information that is extracted indirectly or directly from the employee or the treating healthcare individual 32. This information may be self-reported, for example, through a questionnaire or an interview that is completed by employee. Examples of such information include data relating to family history, current symptoms, previous surgeries, nutrition, smoking and alcohol habits, occupation, gene sequence, medication (past or present), or allergies. Note that because such information may reflect a specific trait of an individual or a population of employees, their specific constraints or conditions may be accounted for and accommodated.

For example, the fact that an employee is an investment banker in Manhattan, N.Y. may reflect a high stress level. Health risk appraisal data 59 could reveal such information, whereby the interview and/or the questionnaire could directly solicit this important fact. Thus, the interview and/or the questionnaire may be customized to address a particular population. Consider another example where the employee base is predominantly women. Appropriate questions for the interview and/or the questionnaire may then be associated with family history and breast cancer (note that gene sequence identification may be part of such an inquisition, as certain identified gene sequences do reveal a greater likelihood of breast cancer) or capabilities related to procreation potential. Numerous other examples of health risk appraisal data 59 are provided herein in this document for purposes of example and illustration. Alternatively, health risk appraisal data 59 could include any other suitable self-reported information, condition, symptom, or any other relevant fact, parameter, or piece of data that is relevant to the health of the individual or the group being evaluated.

As used herein, biometric data 60 reflects measured health information that is not necessarily self-reported. This information may be gathered from (or relate to) the employee and generally reflects physical data, which is measured. Biometric data 60 may relate to diagnostic information that could be provided in a laboratory report or gathered, for example, during the course of a magnetic resonance imaging (MRI) scan, in the context of evaluating a employee, or in performing some type of lab work or blood-work. In other scenarios, biometric data 60 may involve assessing body fat and blood cholesterol, lung capacity (e.g. using a flow meter), height, density and weight measurements, or any other suitable test or evaluation that yields some tangible result for an examining entity 28. In still other embodiments, this could include testing (e.g. psychiatric evaluations) that involves questionnaires, inkblot tests, etc. Alternatively, biometric data 60 could include any other suitable physical measurement, dimension, relevant health fact, parameter, or piece of data that may be collected by a physician, nurse, or representative authorized to do so.

As used herein, utilization data 62 refers to economic data that reflects financial information tied to the person or group being evaluated. This could include how much money is spent on pharmaceutical supplies, or some particular event such as a doctor visit or a trip to an emergency room at a local hospital. Utilization data 62 may be solicited from a third party carrier or a third party administrator or, alternatively, through any other suitable entity 28. This may be inclusive of records searching in an appropriate database or file system. Utilization data 62 may reflect an economic event in which medical service triggered any type of fee. Such data is tied into costs incurred by a participant or by an employer on behalf of the participant. Alternatively, utilization data 62 could include any other suitable information or piece of data that may affect expenses or absenteeism for employee or group that is being evaluated.

Absence manager 26 can generate employee absence reports 54. Reports 54 can be viewed on a web site via display on access terminal 22 by authorized individuals or reports 54 can be sent via email to selected individuals. Employee absence reports 54 are a valuable record that provide entity 28 and healthcare individual 32 with data associated with employee absences. Entity 28 can sort this data a variety of ways to calculate the cost of absenteeism. For example, entity 28 can quickly sort and process data in employee absence reports 54 to determine the average days absent for an employee participating in a wellness program and average days absent for an employee not participating in a wellness program. In another example, healthcare professional can quickly sort out entity's population that was absent due to stress and apply a stress relieving intervention plan for these employees, which will result in fewer absences. Absence manager 26, including employee absence reports 54, can be customized and configurable by authorized individuals to contain a variety of data fields related to absenteeism. For example, company ABC may choose to include a unique data field, such as employee risk level. Authorized individuals can determine if employee is high risk, medium risk, or low risk. Entities and healthcare individuals 32 can develop intervention plans more efficiently and effectively by using customizable data fields in an absence report. Employee absent reports 54 allow authorized individuals to know who is absent, when employees are absent, how frequent employees are absent, and reason for employee's absence. Investigations into what is driving the economics of a given company's absenteeism may be very difficult. Consider another example that is illustrative. An investigation into a given company's absence report may reveal unusually high absences in the month of April for allergy reasons. What is driving this high incidence and the associated absences? A detailed analysis may reveal that this population of employees are not on proper allergy medication. Such investigative and proactive approaches are in stark contrast to prevailing practices of absence reporting programs that simply focus on notifying appropriate individuals of employee's absence. Such practices are administrative tools and not health management tools.

Healthcare individuals 32 can provide an intervention for an employee based on employee's data captured in absence reports 54. Healthcare individual 32 can receive a call from absent employee that is transferred from absence manager 26. In addition, healthcare individual 32 can receive absence report on access terminals 22. Healthcare individual 32 can apply health management of the acute interventions for acute illnesses. Healthcare individuals 32 can apply specific and timely intervention for different employees based on employee's health data 56 and reasons for illness, which will reduce the number of days an employee is absent. Additionally, healthcare individual 32 can apply intervention plans in a preventative way based on employee health data 56 stored on absence manager 26. For example, healthcare individual 32 may enroll all heart attack victims in a heart smart plan, which will prevent absences in the future. Healthcare individuals 32 can include physicians, nurses, or any authorized individual to make intervention decisions using absent employee's health data 56. After an employee reports 54 an absence, employee's call can be automatically transferred to a healthcare individual 32 by the absence manager 26. Employees will be less likely to report fraudulent absences when they are required to explain their absence to a healthcare individual 32 on the phone. Additional details of healthcare individuals 32 applying intervention plans based on employee's health data 56 transmitted from absence manager 26 are listed below in FIG. 2.

In another embodiment, healthcare individual 32 can work for an insurance carrier. Insurance carrier can use absence manager 26 to maximize profitability. Insurance carriers can charge premiums to entities for short term and long term disability. The amount the insurance carrier charges entities for the premiums is based upon risk. Insurance carriers can use absence manager 26 to receive immediate intelligence and data on employee population of entity 28 to limit the costs associated with employee's healthcare. For example, healthcare individual 32 can determine an appropriate intervention plan for employee based on data in employee absence record and reason for absence. This intervention plan can prevent an illness from becoming a short term disability, and prevent a short term disability from becoming a long term disability. Additionally, if a high risk employee gets ill, then carriers can budget for a high risk patient that may go on long term disability. Therefore, absence manager 26 can provide data that has value at the insurer level and at the caretaker level.

In another embodiment, healthcare individuals 32 can determine a risk level for each employee. Employees may be risk-stratified into appropriate categories (e.g. low risk, medium risk, and high risk). Note that such an environment is fluid; it is dynamic and constantly evolving. Such changing health factors, as well as the natural progression of a given disease, can readily be appreciated by medical professionals. Through diligence and a complete investigation, it may be revealed that six of the 5,000 employees had heart attacks and a corresponding bypass surgery. Further, by means of a cost stratification analysis, it may be discovered that these six individuals collectively cost the company almost $200,000 in absenteeism costs. An in-depth evaluation may also uncover that, for these patients, these medical issues have generally been resolved. The conditions that caused the huge expenditures have been alleviated through their surgeries. After consulting with their physicians, it may be confirmed that these patients are stable, their health conditions have been successfully addressed, and the need for ongoing invasive treatment is non-existent over the next twelve months. Moreover, prior costs associated with these patients are not likely to recur. Thus, even these six patients, who were a huge healthcare and absenteeism expenditure for the company, would be placed in the low risk heart disease category for the current absence report.

However, through the same in-depth analysis, it may be revealed that another patient in the heart disease group (“Herman”) had a severe heart attack, has a history of multiple hospitalizations, and, further, that he suffers from congestive heart failure. Herman's condition is not something that can be easily treated by a single event such as a bypass surgery. Herman has a demand for ongoing treatment. Not only is Herman most likely to see his overall health decline, there is a significant risk that Herman's future healthcare expenses and absenteeism will increase because of his condition. Accordingly, Herman would be designated in the high risk heart disease category for future expenses. Therefore, healthcare individuals 32 can provide Herman with preventative intervention plan and continual surveillance to reduce Herman's absenteeism and health costs.

Within a specific disease state (e.g. heart disease, diabetes, lung cancer, etc.) there are relevant risk factors 58, which serve as the basis for ranking the patients into low, medium, or high risk categories. It is the underlying relevant risk factors 58 within the disease state that are critical for determining future absenteeism and healthcare expenses. Additionally, the frequency of absence for every given employee can also contribute to the determination of the appropriate risk category for employee.

Absence manager 26 can notify appropriate entity 28 employees and healthcare individuals 32 when employee reports 54 an absence. Absence manager 26, including notifying others of employee absence, can be customized and configurable by authorized individuals. This feature allows for automated and instant communication to relevant parties. For example, absence manager 26 can be customized for each employee, such that absent employee's manager and clients that employee was scheduled to meet with are notified of employee's absence. Additionally, entity's payroll and benefits department can be notified as well, as well as any other individual. Absence manager 26 can be customized to notify these parties by email, phone call, or any appropriate method of notification. Additionally, absence manager 26 can be customized to only notify certain individuals with certain data. For example, healthcare individual 32 may have access to entire report, but payroll department may only have access to the data fields related to the length of absence.

In another embodiment, absence manager can include a scheduler function. Absence manager can communicate with scheduler in real time and automatically change schedule based on absenteeism data. Scheduler can notify appropriate individuals to replace absent employee. For example, if ten people were assigned to work at a call center on the evening shift and three employees on this shift call in sick, then scheduler in absence manager can request others to come to work. Scheduler allows entity to continue operating at maximum productivity by automatically replacing absent employees with appropriate replacement employees. Scheduler is customizable, such that authorized individuals can choose who should be notified based on a multitude of factors including absent employee, work volume, and time of day.

Processor 64 controls the absence manager 26 by processing information and signals. Processor includes any suitable hardware, software, or both that operate to control and process signals. Processor may be microprocessors, controllers, or any other suitable computing devices, resources, or combination of hardware, software and/or encoded logic.

Interface 66 receives input, sends output, processes the input and/or output, and/or performs other suitable operation. An interface may comprise hardware and/or software.

Display 68 on access terminal 22 is operable to display one or more images in one or more formats. Images viewed in display 58 may include absence reports 54.

FIG. 3 illustrates an example method for collecting data from multiple domains and managing absenteeism based on this data in accordance with one embodiment of the present invention. At step 90, entity 28 and/or healthcare individuals 32 collect data from employee. System 10 may include three domains of information, which are used as a basis for the identification of relevant economic risk factors 58 and for The domains include: health risk appraisal data 59, biometric data 60, and utilization data 62. The information collected may be reviewed and processed in order to highlight relevant economic risk factors 58, which may later be used to develop a specific intervention over a designated time period. Thus, the information collected in this first step may be used as a basis for subsequent steps to be completed in order to manage absenteeism for the targeted population. In the context of an example that includes the use of these three information domains (health risk appraisal data 59, biometric data 60, and utilization data 62), the following scenario is illustrative. A person may complete an interview session in which he answers truthfully that he has asthma and a history of heart disease in his family (this represents health risk appraisal data 59). He may then be tested using a flow meter that indicates he has limited lung capacity (this represents biometric data 60). He may also have his blood evaluated, which in this example yields that he has terribly high cholesterol (this represents biometric data 60). Finally, querying the employee may yield that he purchases several inhalers per month, that he was rushed to the hospital last year for an asthma attack, and that he is currently taking prescription medication to reduce his cholesterol (this represents utilization data 62).

At step 92, relevant risk factors 58 are identified after the data is collected from the three domains. This represents the second step in the process and method for managing healthcare expenditures. The purpose of the risk identification step is to discover relevant risk factors 58 that reflect predictable events or conditions and, further, whose modification can lead to a reduction in absenteeism. Modifying or eliminating a risk factor can prevent future absences.

Let us explore what constitutes risk factors 58. Medical research has determined that the probability of developing a disease or increasing the morbidity of an existing disease state is associated with specific risk factors 58. For example, there are generally five primary modifiable lifestyle risk factors 58 for heart disease: i) smoking, ii) sedentary lifestyle, iii) obesity, iv) high blood pressure, and v) elevated blood lipids. Logically, modifications to these risk factors 58 reduce the risk for disease development, as well as death, disability, and absenteeism resulting from a heart attack. Further, these risk factors 58 may be used in order to develop a specific intervention that fits the needs of the targeted population.

At step 94, absence manager 26 has a report containing population's health risk appraisal data 59, biometric data 60, utilization data 62, risk factors 58, reasons for absence, dates of absence, and several other absence related data. Healthcare individual 32 can sort and process data in report to easily view employee populations associated with a high risk of absenteeism. In addition, absence patterns can be easily seen by medical individuals using absence manager 26. For example, a defined population may consistently be absent for several days in April, and medical individual can also see that the absences are caused by allergies. This provides healthcare individual 32 with specific data to provide an efficient and effective intervention plan to reduce the number of absences associated with this defined population.

At step 96, an intervention can be introduced to address the health data 56 and risk factors 58 contributing to employee's absences. Healthcare individual 32 can determine intervention by analyzing absence report, which contains health data 56, reasons for absences, and date of absences. This allows for a clear and definitive plan of attack for employee to reduce absences. Once the intervention has been deployed, the overall value of the process may be displayed: comparing absences before the intervention and absences after the intervention using a statistically validated method of evaluation. This translates into a tangible result to be compared and validated for any interested party (e.g. the entity 28). Such a protocol avoids speculative claims or prognostications that may or may not prove truthful. This process produces a true bottom line result that can reflect changes in making comparisons year over year. For example, one of entity XYZ's top expenses is related to respiratory absences. Healthcare individual 32 can analyze utilization data 62 and determine that individuals who have had respiratory infections usually get them every year. Now, healthcare individual 32 has identified a defined population of people who experience respiratory infection absences every year when the weather gets cold. Healthcare individuals 32 can interact with absence manager 26 to display employees in this defined population, and see that employees in this defined population average eight days of absence associated with respiratory infections. Therefore, healthcare individual 32 can add these employees to high risk level, such that immediate acute care is provided for any illness associated with respiratory infections. Additionally, healthcare individuals 32 can provide a specific intervention plan to reduce number of absences associated with respiratory infections, such as flu vaccines.

It is important to note that the stages and steps described above illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within absence manager 26 to effectuate the tasks and operations of the elements and activities associated with executing compatibility functions.

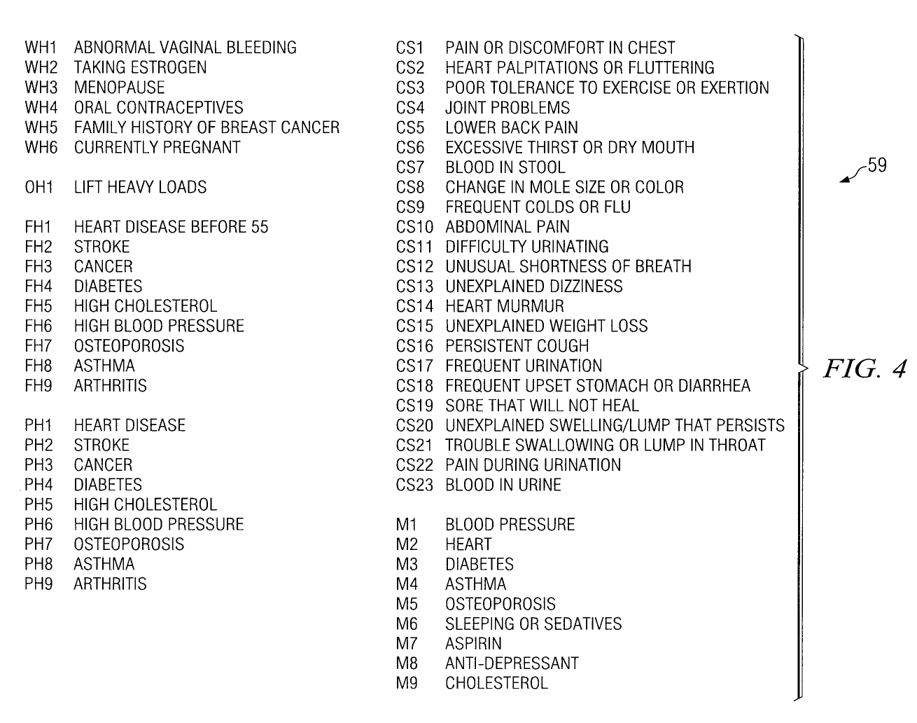

FIG. 4 is an example listing of health risk appraisal data 59. It is critical to note that such a listing has been offered for purposes of example and teaching only, and in no way should be considered exhaustive. Other health attributes can be readily accommodated by system 10 in accordance with particular needs or concerns. A series of codes are listed to the left of each of the data.

FIG. 5 is an example of an example of an absence report, first introduced in FIG. 2, which can be displayed on access terminal 22 in accordance with an embodiment of the present invention. Absence manager 26 can be customized to generate absence report containing data fields selected by authorized individual. In this embodiment, data fields in absence report include employee identification, employee name, risk factors 58, health risk appraisal data 59, biometric data 60, utilization data 62, start of absence, return date, days absent, and reason for absence.

In other embodiments, different data fields can be included in absence reports 54, such as age, weight, gender, risk level, compliance, etcetera.

FIG. 6 is a simplified flowchart that illustrates an example method for managing absenteeism in accordance with an embodiment of the present invention. The example process begins at step 102 when employee calls absence manager 26 to report absence. At step 104, absence manager 26 captures data from employee. Absence manager 26 can be customized to capture different data fields from employee. For example, absence manager 26 may ask employee to input identification number. Employee can input identification number on telephone's keypad. Absence manager 26 can then ask employee if employee is opening or closing an absence. Employee can speak into phone by saying “opening.” Absence manager 26 can then ask employee to record reason for absence. Employee can record an audio message for the reason why employee is calling to report an absence. Absence manager 26 can ask employee to speak or input the length of estimated absence. Absence manager 26 can automatically convert audio messages into text to be included in absence report. Absence manager 26 automatically updates these fields in absence report.

At step 106, absence manager 26 notifies selected individuals of employee's absence, such as employee's manager, payroll department, and benefits department. At step 108, absence manager 26 can instruct employee that absence reporting cannot be completed until employee talks with a healthcare individual 32. Absence manager 26 can forward the current phone session and employee's updated absence report to a healthcare individual 32, such as a physician or nurse.

At step 110, healthcare individual 32 can immediately analyze the employee's absence report, which can include employee name, health data 56, start of absence, return date, days absent, and reason for absence. Health data 56 can include risk factors 58, health risk appraisal data 59, biometric data 60, and utilization data 62. Healthcare individual 32 can ask employee more probing questions about reason for absence or about additional risk factors 58 to consider.

At step 112, healthcare individual 32 can determine an intervention plan designed specifically for employee based on healthcare individual's analysis of employee's reason for absence and data fields in absence report. The intervention plan is designed to minimize employee's absence. For example, if a diabetic employee reports 54 an absence for being sick, then healthcare individual 32 must provide an effective intervention plan. Healthcare individual 32 is knowledgeable about diabetics being susceptible to common pathogens, respiratory infections, urinary tract infections, and skin infections. Healthcare individual 32 knows that if a diabetic employee is not better in 48 hours, then employee could end up with a more serious sickness like pneumonia. Therefore, healthcare individual 32 can provide effective intervention plan by knowing employee's background health data 56 and reason for employee's absence. Healthcare individual 32 can provide acute intervention and acute surveillance by following up with employee. At step 114, employee can avoid hospitalization and additional absences by complying with suggested acute intervention and acute surveillance.

It is important to note that the stages and steps described above illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within absence manager 26 to effectuate the tasks and operations of the elements and activities associated with executing compatibility functions.

Certain features of the invention have been described in detail with reference to particular embodiments in FIGS. 1-6, but it should be understood that various other changes, substitutions, and alterations may be made hereto without departing from the sphere and scope of the present invention. For example, although the preceding FIGURES have referenced a number of relevant health risk factors 58, any suitable characteristics or relevant parameters may be readily substituted for such elements and, similarly, benefit from the teachings of the present invention. These may be identified on a case by case basis, whereby a certain employee may present a health risk factor while another (with the same condition) may not. Thus, a statistical relevance may be identified for one group, but not another who appears to be similar. Additionally, different and unique data fields can be customized in absence reports 54, such as age, weight, gender, risk level, compliance, etcetera.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for managing absenteeism, the method comprising:
capturing health-related data from an employee reporting an absence during a communication session;
interacting with the employee at a remote location;
determining an intervention for the employee based on the health-related data; and
communicating the intervention to the employee.

2. The method of claim 1, further comprising:
receiving a report associated with the employee, wherein the report is updated in real time with the captured health-related data.

3. The method of claim 1, further comprising:
determining a surveillance plan for the employee based on the health-related data; and
following up with the employee based on the surveillance plan.

4. The method of claim 1, further comprising:
identifying one or more relevant risk factors from the health-related data collected from the employee; and
analyzing the risk factors to determine a risk management intervention plan for the employee.

5. The method of claim 1, further comprising receiving additional health-related data from interacting with the employee and applying the additional health-related data to determine an intervention for the employee.

6. The method of claim 1, further comprising notifying appropriate individuals of the absence by the employee.

7. The method of claim 6, wherein the appropriate individual is a selected one of a group of appropriate individuals, the group consisting of:
a) a healthcare individual;
b) a manager of the employee;
c) an individual from payroll department; and
d) an individual from benefits department.

8. The method of claim 1, wherein the intervention is determined by a healthcare individual.

9. The method of claim 1, wherein the health-related data is a selected one of a group of health-related data, the group consisting of:
a) reason for absence;
b) biometric data;
b) utilization data; and
c) health risk appraisal data.

10. The method of claim 1, wherein the interacting with the employee occurs during the communication session of employee reporting the absence.

11. The method of claim 1, wherein the communicating the intervention to employee occurs during the communication session of employee reporting the absence.

12. The method of claim 1, wherein the reason for absence is an acute event.

13. The method of claim 1, wherein the capturing automatically converts audio data associated with the health-related data into electronic text data.

14. The method of claim 1, wherein the report is customizable to display one or more chosen data fields in the report, the data fields consisting of:
a) employee identification number;
b) employee name;
c) risk factors;
d) health risk appraisal data;
e) biometric data;
f) utilization data;
g) start of absence;
h) return date;
i) days absent;
j) reason for absence;
k) risk level;
l) age;
m) gender; and
n) weight.

15. The method of claim 1, wherein the report is received and displayed on a web portal.

16. A system for managing absenteeism, comprising:
an access terminal;
an absence manager operable to:
capture health-related data from an employee during a communication session; and
a healthcare individual operable to:
interact with the employee at a remote location;
determine an intervention for the employee based on the health-related data; and
communicate the intervention to the employee.

17. The system of claim 16, wherein the access terminal is operable to receive a report associated with the employee, wherein the report is updated in real time with the captured health-related data.

18. The system of claim 16, wherein the healthcare individual is further operable to:
determine a surveillance plan for the employee based on the health-related data; and
follow up with the employee based on the surveillance plan.

19. The system of claim 16, wherein the healthcare individual is further operable to:
identify one or more relevant risk factors from the health-related data collected from the employee; and
analyze the risk factors to determine a risk management intervention plan for the employee.

20. The system of claim 16, wherein the healthcare individual is further operable to receive additional health-related data from interacting with the employee and apply the additional health-related data to determine an intervention for the employee.

21. The system of claim 16, further comprising an absence manager operable to notify appropriate individuals of the absence by the employee.

22. The system of claim 21, wherein the appropriate individual is a selected one of a group of appropriate individuals, the group consisting of:
a) a healthcare individual;
b) a manager of the employee;
c) an individual from payroll department; and
d) an individual from benefits department.

23. The system of claim 16, wherein the healthcare individual is a physician.

24. The system of claim 16, wherein the health-related data is a selected one of a group of health-related data, the group consisting of:
a) reason for absence;
b) biometric data;
c) utilization data; and
d) health risk appraisal data.

25. The system of claim 16, wherein the absence manager is further operable to transfer the communication session of the employee reporting the absence to the healthcare individual.

26. The system of claim 16, wherein the healthcare individual is further operable to communicate the intervention to the employee during the communication session.

27. The system of claim 16, wherein the reason for absence is an acute event.

28. The system of claim 16, wherein the absence manager is further operable to automatically convert audio data associated with the health-related data into electronic text data.

29. The system of claim 16, wherein the report is customizable to display one or more chosen data fields in the report, the data fields consisting of:
a) employee identification number;
b) employee name;
c) risk factors;
d) health risk appraisal data;
e) biometric data;
f) utilization data;
g) start of absence;
h) return date;
i) days absent;
j) reason for absence;
k) risk level;
l) age;
m) gender; and
n) weight.

30. The system of claim 16, wherein the report is received and displayed on a web portal.

31. A method for managing absenteeism, the method comprising:
interacting with an employee at a remote location to obtain health-related data during a communication session;
determining an intervention for the employee based on the health-related data; and
communicating the intervention to the employee during the communication session.

32. The method of claim 31, further comprising:
determining a surveillance plan for the employee based on the health-related data; and
following up with the employee based on the surveillance plan.

33. The method of claim 31, further comprising:
identifying one or more relevant risk factors from the health-related data collected from the employee; and
analyzing the risk factors to determine a risk management intervention plan for the employee.

34. A system for managing absenteeism, comprising:
means for capturing health-related data from an employee during a communication session;
means for interacting with the employee at a remote location;
means for determining an intervention for the employee based on the health-related data; and
means for communicating the intervention to the employee.
